(19) United States
(12) Patent Application Publication
(10) Pub. No.: US 2007/0149705 A1
(43) Pub. Date: Jun. 28, 2007

(54) Rubber modified styrenic copolymer composition comprising partially hydrogenated elastomers

(75) Inventors: Thomas J. Styranec, Poland, OH (US); Steven M. Krupinski, Pittsburgh, PA (US)

Correspondence Address: Gary F. Matz/NOVA Chemicals Inc., Westpointe Center, 1550 Coraopolis Heights Road, Moon Township, PA, 15108, US

(73) Assignee: NOVA Chemicals Inc.

(21) Appl. No.: 11/642,223

(22) Filed: Dec. 20, 2006

Related U.S. Application Data
(60) Provisional application No. 60/753,347, filed on Dec. 22, 2005.

(51) Int. Cl. C08L 53/00

(52) U.S. Cl. 525/88

(57) ABSTRACT

A styrenic copolymer composition comprising 55% to 94% by weight of one or more styrenic monomers; 2% to 25% by weight of one or more maleate-type monomers; and 4% to 20% by weight of an elastomer composition comprising one or more partially hydrogenated elastomeric polymers comprising repeat units from one or more monomers according to the formula 63% 1,4 cis/trans butadiene, 1% 1,2 vinyl butadiene, 26% tetramethylene, and 10% butylene. The styrenic copolymer composition may also comprise one or more high molecular weight elastomeric polymers having a number average molecular weight of greater than 12,000 and optionally, polybutene. The styrenic copolymer composition is formed via polymerizing methods. A thermoplastic sheet is made by extruding the polymer melt composition to provide a thermoplastic sheet. The thermoplastic sheets can be thermoformed into containers suitable for use in microwave heating of food.

### CROSS REFERENCE TO RELATED PATENT APPLICATION

The present non-provisional patent application is entitled to and claims, under 35 U.S.C. § 119(e), the benefit of U.S. Provisional Patent Application No. 60/753,347, filed Dec. 22, 2005, which is hereby incorporated herein in its entirety by reference.

### BACKGROUND OF THE INVENTION

1. Field of the Invention

The present invention relates to rubber modified styrenic copolymers that include partially hydrogenated elastomers; to articles of manufacture, e.g., thermoformed containers suitable for packaged foods that are to be heated in microwave ovens, produced from the rubber modified styrenic copolymers and having improved properties, e.g., toughness, elongation, swell index, and heat distortion resistance; and to related methods for producing the rubber modified styrenic copolymers.

2. Background Art

It is known to copolymerize styrene and maleic anhydride. Such processes have been described at length in the literature, especially in Baer U.S. Pat. No. 2,971,939 and Hanson U.S. Pat. No. 2,769,804, and beneficially as a solution as disclosed in U.S. Pat. No. 3,336,267.

It is further known to modify styrene maleic anhydride (SMA) copolymers with rubber. Generally, these copolymers are referred to as “rubber modified styrene/maleic anhydride copolymers”. It is known that the rubber component provides increased impact resistance and that the maleic anhydride component provides a high heat distortion temperature. An improved method for preparing styrene/maleic anhydride/diene rubber composition suitable for extrusion and molding and having a high heat distortion temperature and desired impact resistance is disclosed in Moore et al. U.S. Pat. No. 3,191,354 (The Dow Chemical Company) issued on Nov. 11, 1975.

U.S. Pat. No. 5,219,628 discloses a multi-layer container for use in the microwave cooking of food. The container comprises a substrate layer of thermoplastic polymer that is not suitable for contact with the food, and an inner layer comprised of a blend of styrene/maleic anhydride copolymer and a polymer selected from the group consisting of polystyrene, rubber modified polystyrene, polymethyl methacrylate, rubber modified polymethyl methacrylate, polypropylene, and mixtures thereof. This patent also teaches that rubber modified styrene/maleic anhydride copolymers may also be used, but are not preferred.

It is also known to produce various shaped articles from foamed and unfoamed thermoplastic materials such as polystyrene sheet or impact modified polystyrene sheet (i.e., high impact polystyrene sheet) by thermoforming methods. Many such articles are containers used for packaged foods.

U.S. Pat. No. 5,106,696 discloses a thermoformable multi-layer structure for packaging materials and foods. A first layer includes a polymer composition containing 49% to 90% by weight of a polyolefin, 10% to 30% by weight of a copolymer of styrene and maleic anhydride, 2% to 20% by weight of a compatilizing agent, 0 to 5% by weight of a triblock copolymer of styrene and butadiene, and 20% by weight of talc. The second layer of the structure is made of polypropylene.

It is further known to improve the environmental stress crack resistance (ESCR) of high impact polystyrene (HIPS) and other impact modified styrenic polymers, such as acrylonitrile-butadiene-styrene plastic (ABS) and methyl methacrylate-butadiene-styrene plastics (MBS), with the addition of polybutene.

U.S. Application Publication 2005/0020756 (U.S. Ser. No. 10/807,621 filed Mar. 24, 2004) discloses a styrenic resin composition comprising a rubber modified styrene maleic anhydride (SMA) copolymer and polybutene which can be thermoformed into a container suitable for packaged foods that are to be heated in microwave ovens.

U.S. Pat. No. 5,543,461 discloses a rubber modified graft thermoplastic composition comprising: 1) 99 to 96% by weight of a rubber modified thermoplastic comprising: (a) 4 to 15 weight % rubbery substrate, preferably polybutadiene, that is distributed throughout a matrix of the superstrate polymer in particles having a number average particle size from 6 to 12 microns and (b) 96 to 85% by weight of a superstrate polymer; and 2) 1 to 4% by weight of polybutene having a number average molecular weight from 900 to 2000. Claim 10 of this patent recites that the superstrate polymer may comprise 85% to 95% by weight of styrene and from 5% to 15% by weight of maleic anhydride. Such thermoplastics find a fairly significant market in housewares, which are subject to chemicals that tend to cause environmental stress cracking (ESC), such as cleaners and in some cases, fatty or oily food.

A number of process designs are disclosed in the patent literature involving polymerization techniques, reactor configurations and mixing schemes that are used to incorporate maleic anhydride in a styrene/maleic anhydride copolymer. Examples include U.S. Pat. Nos. 4,328,327, 4,921,906, and 3,919,354.

U.S. Pat. No. 3,919,354 discloses an improved styrene/maleic anhydride/diene rubber composition suitable for extrusion and molding and having a high heat distortion temperature and desired impact resistance. The process for the preparation of the polymer involves modifying a styrene-maleic anhydride copolymer with diene rubber by polymerizing the styrene monomer and the anhydride in the presence of the rubber. More particularly, the process involves providing a styrene having rubber dissolved therein; agitating the styrene/rubber mixture and initiating free radical polymerization thereof; adding to the agitated mixture the maleic anhydride at a rate substantially less than the rate of polymerization of the styrene monomer; and polymerizing the styrene monomer and the maleic anhydride. The polymer contains rubber particles ranging from 0.02 to 30 microns dispersed throughout a matrix of polymer of the styrene monomer and the anhydride with at least a major portion of the rubber particles containing occlusions of the polymerized styrene monomer and maleic anhydride. This patent teaches that the polymers are suited for extrusion into sheet or film, which is then employed for thermoforming into containers, packages and the like. Alternately, the polymers can be injection molded into a wide variety of components such as dinnerware and heatable frozen food containers.

However, polymers as those disclosed in the above U.S. Pat. No. 3,919,354 are generally brittle, and therefore, capable of breaking even though these polymers have the thermal properties to withstand temperatures above 210° F., which temperature is generally used in heating food in a microwave oven.

There is a need in the art for an improved rubber modified styrenic copolymer and improved articles, such as containers that are suitable for packaged foods that can withstand the temperatures needed for heating foods in a microwave oven without the container warping, deforming, or breaking.

### SUMMARY OF THE INVENTION

The invention has met these needs. The inventors have found that a rubber modified styrenic copolymer having an elastomer component that includes a partially hydrogenated rubber is particularly useful for thermoforming articles, i.e., especially food containers for use in heating foods in microwave ovens, and which rubber modified styrenic copolymer has excellent heat resistance properties, as well as excellent toughness and elongation properties.

The rubber modified styrenic copolymer comprises:

about 55% to about 94% by weight of one or more styrenic monomers; and

about 2% to about 25% by weight of one or more maleate-type monomers; and

about 4% to about 20% by weight of an elastomer composition comprising:

about 4% to about 20% by weight, based on the weight of the styrenic copolymer, of one or more partially hydrogenated elastomeric polymers comprising repeat units from one or more monomers including 1,4 cis or trans butadiene, 1,2 vinyl butadiene, tetra methylene, and butylenes.

In some embodiments of the invention, the elastomer composition may be further comprised of about 0.1 to about 16% by weight, based on the weight of the styrenic copolymer, of one or more high molecular weight elastomeric polymers having a number average molecular weight of greater than 12,000.

In some embodiments, the elastomer composition may be further comprised of about 0.1 to about 8.0% by weight based on the weight of the styrenic copolymer, of polybutene.

The present invention is also directed to a thermoplastic sheet comprised of the above described rubber modified styrenic copolymer.

The present invention further provides a method for polymerizing the above-described rubber modified styrenic copolymer.

The present invention is also directed to a method of making a thermoplastic sheet that includes providing the above-described rubber modified styrenic copolymer in melt form and extruding the copolymer to provide a thermoplastic sheet.

The present invention further provides articles produced from the above-described thermoplastic sheets as well as containers suitable for use in microwave heating of food formed from the above-described thermoplastic sheets.

The present invention additionally provides a container suitable for use in microwave heating of food formed by thermoforming the above-described thermoplastic sheet.

The rubber particle size generally will range from about 0.1 micron to about 11 microns.

The rubber modified styrenic copolymer may be prepared by polymerizing the elastomer components of the elastomer composition, the styrene monomers, and the maleate-type monomers in a suitable reactor under free radical polymerization conditions. The elastomer components, if comprised of two or more components may be added to the styrene/maleate monomer feed, or can be added to or in the polymerization reactor vessel, or can be added to the partially polymerized syrup after it exits the reactor and enters the devolatilizer. It may also be envisioned that the elastomer composition, if comprised of two or more components, may be compounded, i.e., mixed into the styrene/maleate polymer after the polymer has exited the devolatilizer, via an extruder, e.g., a twin-screw extruder, either in line or off line as a separate operation after the styrene/maleate copolymer has been pelletized. However, the inventors have found that the polymerizing method for adding the elastomer components to the styrene/maleate polymer is preferred.

The invention also provides for an extruded thermoplastic sheet made from the rubber modified styrenic copolymer of the invention, as well as thermoformed articles made from the sheet. An example of an article is a container for packaged foods that is to be heated, particularly in a microwave oven, and which article has improved toughness, elongation, and heat distortion resistance properties.

Furthermore, there is provided a multi-layer thermoplastic composite comprising a substrate layer and a layer made from the rubber modified styrenic copolymer of the invention, which multi-layer composite can be thermoformed into articles, e.g., containers suitable for heating purposes in microwave ovens, and which articles have improved toughness, elongation, and heat distortion resistance properties.

These and other objects of the present invention will be better appreciated and understood by those skilled in the art from the following description and appended claims.

### DETAILED DESCRIPTION OF THE INVENTION

Other than in the operating examples or where otherwise indicated, all numbers or expressions referring to quantities of ingredients, reaction conditions, etc. used in the specification and claims are to be understood as modified in all instances by the term “about”. Accordingly, unless indicated to the contrary, the numerical parameters set forth in the following specification and attached claims are approximations that can vary depending upon the desired properties, which the present invention desires to obtain. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

As used herein, the term “polymer” is meant to encompass, without limitation, homopolymers, copolymers and graft copolymers.

As used herein, the term “high impact polystyrene” refers to rubber-modified polystyrene as is known in the art. Also, “crystal polystyrene” refers to polystyrene that does not contain other polymers, a non-limiting example being rubber.

As used herein, “rubber-modified copolymers of styrene and maleic anhydride and/or C₁-C₁₂ linear, branched or cyclic alkyl (meth)acrylates” refer to polymer compositions that include copolymers of styrene and maleic anhydride and/or C₁-C₁₂ linear, branched or cyclic alkyl (meth)acrylates and a rubber and that may be encompassed by the description of the present copolymer and in particular may include the elastomer composition, including the partially hydrogenated rubber as described herein.

Unless otherwise specified, all molecular weight values are determined using gel permeation chromatography (GPC) using appropriate polystyrene standards. Unless otherwise indicated, the molecular weight values indicated herein are weight average molecular weights (Mw).

As used herein, the terms “thermoplastic material” and “thermoplastic sheet” refer to materials that are capable of softening, fusing, and/or modifying their shape when heated and hardening again when cooled.

The present invention is directed to a thermoplastic sheet. As used herein, the term “thermoplastic sheet” refers to a sheet having a length corresponding to the extruding direction (machine direction) of an extruder, a width corresponding to the direction perpendicular (traverse direction) to the extruding direction and a thickness. The thermoplastic sheet is characterized as containing a thermoplastic material that includes the rubber modified styrenic copolymer of the invention.

The thermoplastic material in the present invention contains a rubber modified styrenic copolymer formed by polymerizing a polymerization mixture containing one or more styrenic monomers, one or more maleate-type monomers, and combining the copolymer with an elastomer composition comprising one or more high molecular weight elastomeric polymers and one or more partially hydrogenated elastomer polymers.

The styrenic monomers are present in the polymerization mixture and/or the formed copolymer at a level of at least 55%, in some cases at least 60% and in other cases at least 65% and can be present at up to 94%, in some cases up to 90%, in other cases up to 80%, and in some situations up to 75% by weight based on the polymerization mixture and/or the formed copolymer. The styrenic monomers can be present in the polymerization mixture and/or the formed copolymer at any level or can range between any of the values recited above.

Any suitable styrenic monomer can be used in the invention. Suitable styrenic monomers are those that provide the desirable properties in the present thermoplastic sheet as described below. Non-limiting examples of suitable styrenic monomers include styrene, p-methyl styrene, α-methyl styrene, tertiary butyl styrene, dimethyl styrene, nuclear brominated or chlorinated derivatives thereof and combinations thereof.

The maleate-type monomers are present in the polymerization mixture and/or the formed copolymer at a level of at least 2%, in some cases at least 5% and in other cases at least 10% and can be present at up to 15%, in some cases up to 20%, and in other cases up to 25% by weight based on the polymerization mixture and/or the formed copolymer.

The maleate-type monomers can be present in the polymerization mixture and/or the formed copolymer at any level or can range between any of the values recited above.

Any suitable maleate-type monomer can be used in the invention. Suitable maleate-type monomers are those that provide the desirable properties in the present thermoplastic sheet as described below and include anhydrides, carboxylic acids and alkyl esters of maleate-type monomers, which include, but are not limited to maleic acid, fumaric acid and itaconic acid. Specific non-limiting examples of suitable maleate-type monomers include maleic anhydride, maleic acid, fumaric acid, C₁-C₁₂ linear, branched or cyclic alkyl esters of maleic acid, C₁-C₁₂ linear, branched or cyclic alkyl esters of fumaric acid, itaconic acid, C₁-C₁₂ linear, branched or cyclic alkyl esters of itaconic acid, and itaconic anhydride.

The elastomeric polymers of the elastomer composition of the rubber modified styrenic copolymer of the invention are combined with the styrene and maleate type monomers and, in a particular embodiment of the invention, are present in the polymerization mixture at a level of at least 4%, in some cases at least 8%, in other cases at least 10%, and in some instances at least 12% and can be present at up to 15%, and in some cases up to 20% by weight based on the polymerization mixture and/or the formed copolymer. The elastomeric polymers can be present at any level or can range between any of the values recited above.

In some embodiments, the elastomer composition of the styrenic copolymer of the invention may be comprised of one or more high molecular weight elastomeric polymers in an amount ranging from about 0.1 to 16% by weight, based on the weight of the rubber modified styrenic copolymer. The high molecular weight elastomeric polymers can be present in the polymerization mixture and/or the formed copolymer at any level or can range between any of the values recited above.

Any suitable high molecular weight elastomeric polymer can be used in the invention. In some embodiments of the invention, combinations of high molecular weight elastomeric polymers are used to achieve desired properties. Suitable high molecular weight elastomeric polymers are those that provide the desirable properties in the present thermoplastic sheet as described below and are desirably capable of resuming their shape after being deformed.

In an embodiment of the invention, the high molecular weight elastomeric polymers include, but are not limited to homopolymers of butadiene or isoprene or other conjugated diene, and random, block, AB diblock, or ABA triblock copolymers of a conjugated diene (non-limiting examples being butadiene and/or isoprene) with a styrenic monomer as defined above and/or acrylonitrile.

In a particular embodiment of the invention, the high molecular weight elastomeric polymers of the elastomer composition of the rubber modified styrene maleic anhydride copolymer include one or more block copolymers selected from diblock and triblock copolymers of styrene-butadiene, styrene-butadiene-styrene, styrene-isoprene, styrene-isoprene-styrene, partially hydrogenated styrene-isoprene-styrene and combinations thereof.

As used herein, butadiene refers to 1,3-butadiene and when polymerized, to repeat units that take on the 1,4-cis, 1,4-trans and 1,2-vinyl forms of the resulting repeat units along a polymer chain.

In the invention, the high molecular weight elastomeric polymers have a number average molecular weight (Mn) greater than 12,000, in some cases greater than 15,000, and in other cases greater than 20,000 and a weight average molecular weight (Mw) of at least 25,000 in some cases not less than about 50,000, and in other cases not less than about 75,000 and the Mw can be up to 500,000, in some cases up to 400,000 and in other cases up to 300,000. The weight average molecular weight of the high molecular weight elastomeric polymers can be any value or can range between any of the values recited above.

Non-limiting examples of suitable block copolymers that can be used in the invention include the STEREON® block copolymers available from the Firestone Tire and Rubber Company, Akron, Ohio; the ASAPRENE™ block copolymers available from Asahi Kasei Chemicals Corporation, Tokyo, Japan; the KRATON® block copolymers available from Kraton Polymers, Houston, Tex.; and the VECTOR® block copolymers available from Dexco Polymers LP, Houston, Tex.

In a preferred embodiment, the rubber modified styrenic copolymer comprises an elastomer composition comprised of from about 4% to about 20% by weight of one or more partially hydrogenated elastomer polymers. In some cases, the partially hydrogenated elastomeric polymers may range up to least 5.0% and can be present at up to 10%, in some cases up to 15%, and in other cases up to 20% by weight based on the polymerization mixture and/or the formed copolymer. The one or more partially hydrogenated elastomer polymers can be present in the polymerization mixture and/or the formed copolymer at any level or can range between any of the values recited above.

A suitable “partially hydrogenated” elastomeric polymer for use in the invention is ASAHI H-300A rubber product available from ASAHI.

Other suitable partially hydrogenated elastomer polymers can be used in the invention. In some embodiments of the invention, combinations of partially hydrogenated elastomer polymers are used to achieve desired properties.

Suitable partially hydrogenated elastomer polymers include repeat units of butadiene and ethylene.

In an embodiment of the invention, the partially hydrogenated elastomeric polymers include repeat units resulting from the partially hydrogenation of butadiene.

In an embodiment of the invention, the partially hydrogenated elastomeric polymers include one or more functional groups selected from 1,4 cis butadiene, 1,4 trans butadiene, 1,2 vinyl butadiene, tetramethylene, and butylene.

The partially hydrogenated elastomeric copolymers can have a number average molecular weight of at least 12,000, in some cases at least 15,000, and in other cases at least 20,000 and up to 50,000, in some circumstances up to 75,000, in other circumstances up to 100,000, in some cases up to 150,000, in other cases up to 250,000 and in some instances up to 500,000. The molecular weight can be determined using gel permeation chromatography (GPC) using polystyrene standards. The molecular weight can be any value or can range between any of the values recited above.

In a particular embodiment of the invention, the partially hydrogenated elastomeric polymers include styrene butadiene rubbers. Suitable styrene butadiene rubbers that can be used in the invention include, but are not limited to the rubber products available from ASAHI, i.e., ASAHI L601.

In another particular embodiment of the invention, the partially hydrogenated elastomeric polymers include polybutadienes. Suitable polybutadienes that can be used as the partially hydrogenated elastomer polymers of the invention include, but are not limited to the H300® products available from ASAHI.

In a particular embodiment of the invention, the partially hydrogenated polybutadienes can contain particular proportions of 1,4-cis, 1,4-trans and 1,2-vinyl repeat units. In this embodiment, the 1,4-cis portion can be at least 20%, in some cases at least 40% and in other cases at least 30% and can be up to 70%, in some cases up to 40% and in other cases up to 50% by weight of the low molecular weight polybutadienes. Further, the 1,4-trans portion can be at least 5%, in some cases at least 10% and in other cases at least 15% and can be up to 30%, in some cases up to 25% and in other cases up to 20% by weight of the low molecular weight polybutadienes. Additionally, the 1,2-vinyl portion can be at least 25%, in some cases at least 55% and in other cases at least 60% and can be up to 80%, in some cases up to 75% and in other cases up to 70% by weight of the low molecular weight polybutadienes.

The total of the 1,4-cis, 1,4-trans and 1,2-vinyl portions of the low molecular weight polybutadiene repeat units does not exceed 100% by weight of the polybutadienes, but can be less than 100%. The amount of 1,4-cis, 1,4-trans and 1,2-vinyl portions of the low molecular weight polybutadiene repeat units can be any of the values or range between any of the values recited above. The polymer can also have up to 100% tetramethylene or butylenes.

In an embodiment of the invention, the partially hydrogenated elastomeric polymers include, but are not limited to, a polybutadiene rubber, available under the trade name ASAHI H300A obtained from Asahi, Japan. This polybutadiene rubber is about 37% hydrogenated and has a molecular structure of 63% 1,4-cis/trans; 1% 1,2-vinyl; 26% tetramethylene; 10% butylenes; and a solution viscosity of 75 cps. The basic structural formula is:

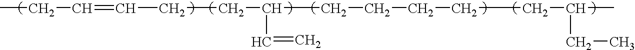

The rubber modified styrenic copolymer of the invention may also be comprised of polybutene as taught in the above-discussed U.S. Application Publication 2005/0020756, the teachings of which are incorporated herein in their entirety. The amount of polybutene may range from about 0.1 to about 8.0% by weight based on the weight of the styrenic copolymer. It is envisioned that the polybutadiene rubber portion presently being used in this rubber modified styrenic copolymer be replaced in part or in its entirety with the partially hydrogenated rubber of the invention.

The use of the partially hydrogenated rubber in the copolymer of U.S. Application Publication 2005/0020756 may significantly reduce the butadiene dimer and styrene monomer residuals, thereby producing a rubber modified styrenic copolymer with less odor and increased toughness. As disclosed in U.S. Application Publication 2005/0020756, the components for producing the rubber modified styrenic copolymer composition are generally processed in an extrusion devolatilization process. The butadiene dimer causing the odor problems may be generated in this devolatilization process. Since partially hydrogenated rubber tends to be a more stable rubber, it is proposed by the inventors that such a partially hydrogenated rubber be used in the rubber modified styrenic copolymer of U.S. Application Publication 2005/0020756.

The polymer composition may be prepared by polymerizing the polymerization mixture in a suitable reactor under free radical polymerization conditions. The elastomer composition, i.e., the high molecular weight elastomer, the partially hydrogenated elastomer, and the polybutene, can be added to a styrenic monomer/maleate-type monomer feed, or can be added to or in the polymerization reactor vessel, or can be added to the partially polymerized syrup after it exits the reactor and enters the devolatilizer. It is also envisioned that the components of the elastomer composition can be compounded, i.e., mixed into the copolymer after the copolymer has exited a devolatilizer, via an extruder, e.g., a twin-screw extruder, either in line or off line as a separate operation after the rubber-modified SMA copolymer has been pelletized. However, as stated herein above the preferred method is in reactor polymerization.

The term “devolatilizer” and the term “devolatilizing system” as used herein are meant to include all shapes and forms of devolatilizers including an extruder and/or a falling strand flash devolatilizer. The term “devolatilizing” and the term “devolatilizing step” as used herein are meant to refer to a process, which can include an extruder and/or a falling strand flash devolatilizer.

In an embodiment of the invention, the partially hydrogenated elastomer is combined or blended with the high molecular weight elastomer and optionally polybutene, and the components are added to the reacting mixture of styrenic monomer and maleate-type monomer before the devolatilization step to improve toughness, elongation, and heat distortion resistance properties of the styrenic copolymer, thermoplastic sheets, and articles made according to the invention. This styrenic copolymer can be used in applications where prior art resins have proven to be too brittle and/or the heat distortion resistance is inadequate. For example, and as discussed hereinabove, if containers for packaged foods made from the rubber-modified styrenic/maleic anhydride resins of the prior art are heated in microwave ovens at temperatures higher than 210° F. (91° C.), the containers generally break when they are taken out of the oven. The thermoplastic sheet of the present invention can now be used in making these types of containers without the containers breaking under normal usage.

It is believed that the addition of the partially hydrogenated elastomer and the high molecular weight elastomer of the elastomer composition or rubber composition of the styrenic copolymer before devolatilizing may distribute the partially hydrogenated elastomer such that it may enhance the properties of the high molecular weight elastomer component. That is, the partially hydrogenated elastomer polymer may gravitate toward, surround and migrate into the high molecular weight elastomer and not the forming styrenic/maleate-type monomer component in view of the high polarity of the styrenic/maleate-type monomer matrix. It is further theorized that the partially hydrogenated rubber may increase the stability of the rubber through the high temperature devolatilization process and may also reduce the crosslinking of the rubber.

Preferably, the styrenic copolymer of the invention is prepared via polymerization techniques; however, there may be some instances where the copolymer is prepared via compounding techniques, both of which are known to those skilled in the art.

It has been found that the addition of the blended partially hydrogenated elastomer and optionally the high molecular weight elastomer and the polybutene to the reactor or to the syrup exiting the reactor and prior to it entering the devolatilizer can provide an even higher degree of improvement in toughness, elongation, and heat distortion resistance properties compared to the addition of the elastomer composition in a compounding technique.

The polymerization techniques used in polymerizing the components of the styrenic copolymer of the invention can be solution, mass, bulk, suspension, or emulsion polymerization. In an embodiment of the invention, bulk polymerization methods are used.

The styrenic copolymer composition of the invention may be prepared by reacting styrenic monomers, maleate-type monomers, and the elastomer components in a suitable reactor under free radical polymerization conditions. Desirably the maleate-type monomers are added to the styrenic monomers and the elastomers continuously at about the rate of reaction to a stirred reactor to form a styrenic copolymer having a uniform maleate-type monomer level.

Polymerization of the polymerization mixture can be accomplished by thermal polymerization generally between 50° C. and 200° C.; in some cases between 70° C. and 150° C.; and in other cases between 80° C. and 140° C. Alternately free-radical generating initiators can be used.

Non-limiting examples of free-radical initiators that can be used include benzoyl peroxide, 2,4-dichlorobenzoyl peroxide, di-tert-butyl peroxide, tert-butyl peroxybenzoate, dicumyl peroxide, cumene hydroperoxide, diisopropylbenzene hydroperoxide, diisopropyl peroxydicarbonate, tert-butyl perisobutyrate, tert-butyl peroxyisopropylcarbonate, tert-butyl peroxypivalate, methyl ethyl ketone peroxide, stearoyl peroxide, tert-butyl hydroperoxide, lauroyl peroxide, azo-bis-isobutyro-nitrile and mixtures thereof.

Generally, the initiator is included in the range of 0.001 to 1.0% by weight, and in some cases on the order of 0.005 to 0.5% by weight of the polymerization mixture, depending upon the monomers and the desired polymerization cycle.

In an embodiment of the invention, the styrenic copolymer is prepared by solution or bulk polymerization in the presence of from 0.01 to 0.1 weight % based on the mixture of a tetra functional peroxide initiator of the formula: 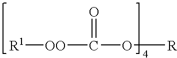
where R¹ is selected from C₄₋₆ t-alkyl radicals and R is a neopentyl group, in the absence of a crosslinking agent. In a particular embodiment of the invention, the tetrafunctional initiator is selected from the group consisting of tetrakis-(t-amylperoxy-carbonyloxymethyl)methane, and tetrakis-(t-butyl-peroxycarbonyloxymethyl)methane.

In some cases, the required total amount of initiator is added simultaneously with the feedstock when the feedstock is introduced into the reactor.

Customary additives known in the art, such as stabilizers, antioxidants, lubricants, fillers, pigments, plasticizers, etc., can be added to the polymerization mixture. If desired, small amounts of antioxidants, such as alkylated phenols, e.g., 2,6-di-tert-butyl-p-cresol, phosphates such as trinonyl phenyl phosphite and mixtures containing tri(mono and dinonyl phenyl)phosphates, can be included in the feed stream. Such materials, in general, can be added at any stage during the polymerization process.

A polymerization reactor that can be used in producing the polymer composition of the invention is similar to that disclosed in the aforesaid U.S. Pat. Nos. 2,769,804 and 2,989,517, the teachings of which patents are incorporated in their entirety herein by reference. These configurations are adapted for the production, in a continuous manner, of solid, moldable polymers and copolymers of vinylidene compounds, particularly that of monovinyl aromatic compounds, i.e. styrene. Of these two arrangements, that of U.S. Pat. No. 2,769,804 is particularly desirable. Further, the styrenic copolymer of the present invention can be prepared as disclosed in U.S. Application Publication 2005/0020756.

In general the arrangement of U.S. Pat. No. 2,769,804 provides for an inlet or inlets for the monomers or feedstock connected to the polymerization reactor vessel. The reactor vessel is surrounded by a jacket, which has an inlet and an outlet for passage of a temperature control fluid through the jacket, and a mechanical stirrer. A valve line leads from a lower section of the vessel and connects with a devolatilizer, which can be any of the devices known in the art for the continuous vaporization and removal of volatile components from the formed resin exiting the vessel.

For example, the devolatilizer can be a vacuum chamber through which thin streams of heated resin material pass, or a set of rolls for milling the heated polymer inside of a vacuum chamber, etc. The reactor is provided with usual means such as a gear pump for discharging the heat-plastified polymer from the reactor to the devolatilizer. A vapor line leads from the devolatilizer to a condenser, which condenses the vapors and affects the return of the recovered volatiles, e.g., monomeric material, typically in liquid condition as a recycle stream.

In general, the arrangement for producing the styrenic copolymer will include at least three apparatuses. These are a polymerization reactor vessel assembly that can include one or more reactor vessels, a devolatilizing system, and a pelletizer. As discussed hereinabove, some embodiments according to the invention utilize processes where the low molecular weight polymer is added to the polymer at one of three locations, i.e., to the reactor vessel; after the reactor vessel and prior to the devolatilizing system; or in a pelletizing extruder wherein compounding or mixing of the polybutene into the polymer occurs.

More particularly, a first method for preparing the styrenic copolymer of the invention is to prepare a solution of the components, i.e., the elastomer composition, the maleate-type monomers, and optionally an antioxidant and to dissolve this solution in the styrenic monomers which then is fed continuously to a polymerization reactor vessel that is equipped with a turbine agitator similar to that described in the preceding paragraph. The initiator can be added to the reactor vessel in a second stream. The reactor is stirred so that the contents are well mixed and the temperature is maintained by the cooling fluid flowing in the reactor jacket. The exit stream is continuously fed into the devolatilizer (first extruder), and the final product is pelletized.

A second method involves adding the styrenic monomer, the maleate-type monomer feed separately to the polymerization reactor vessel and then polymerizing the feed in the presence of the elastomer composition followed by devolatilizing the stream that exits the reactor vessel. The finished product can be pelletized after the devolatilizing system.

A third method involves forming a solution of maleate-type monomer and the styrenic monomer, continuously feeding this solution with the styrenic monomer into the polymerization reactor vessel to produce a partially polymerized styrenic syrup, and adding the elastomer composition to the partially polymerized syrup as it exits the reactor vessel and prior to this syrup entering the devolatilizing system. The finished product can be pelletized after the devolatilizing system.

A fourth method involves forming a solution of maleate-type monomer and the styrenic monomer, continuously feeding the solution with the styrenic monomer into a polymerization reactor vessel to produce a partially polymerized styrenic syrup, devolatilizing the stream exiting the polymerization reactor vessel, and compounding or mixing the elastomer composition into the polymer stream either in an in-line extruder followed by pelletizing or in a separate extrusion step after the rubber-modified styrenic monomer-maleate-type monomer copolymer has been pelletized.

A fifth method involves forming a copolymer of maleate-type monomer and styrenic monomer and subsequently compounding the elastomer composition into the copolymer.

The polymerization generally occurs at a conversion of from 20 to 95%.

Typically, the polymerization process results in the styrenic and maleate-type monomers copolymerizing to form a continuous phase with the elastomer composition present in a dispersed phase. In an embodiment of the invention, at least some of the polymers in the continuous phase are grafted onto the elastomer polymers in the dispersed phase.

In an embodiment of the invention, the dispersed phase is present as discrete particles dispersed within the continuous phase. Further to this embodiment, the volume average particle size of the dispersed particulate phase in the continuous phase is at least about 0.1 μm, in some cases at least 0.5 μm and in other cases at least 1 μm. Also, the volume average particle size of the dispersed phase in the continuous phase can be up to about 11 μm, in some cases up to 6 μm, in other cases up to 5.5 μm, in some instances up to 5 μm and in other instances up to 4 μm. The particle size of the dispersed phase in the continuous phase can be any value recited above and can range between any of the values recited above.

In another embodiment of the invention, the aspect ratio of the discrete particles is from at least about 1, in some cases at least about 1.5 and in other cases at least about 2 and can be up to about 5, in some cases up to about 4 and in other cases at least up to about 3. The aspect ratio of the dispersed discrete particles can be any value or range between any of the values recited above. As a non-limiting example, the aspect ratio can be measured by scanning electron microscopy or light scattering.

The average particle size and aspect ratio of the dispersed phase can be determined using low angle light scattering. As a non-limiting example, a Model LA-910 Laser Diffraction Particle Size Analyzer available from Horiba Ltd., Kyoto, Japan can be used. As a non-limiting example, a rubber-modified polystyrene sample can be dispersed in methyl ethyl ketone. The suspended rubber particles can then be placed in a glass cell and subjected to light scattering. The scattered light from the particles in the cell can be passed through a condenser lens and converted into electric signals by detectors located-around the sample cell. As a non-limiting example, a He—Ne laser and/or a tungsten lamp can be used to supply light with a shorter wavelength. Particle size distribution can be calculated based on Mie scattering theory from the angular measurement of the scattered light.

The resulting copolymer from the above-described processes can have a weight average molecular weight (Mw, measured using GPC with polystyrene standards) of at least 20,000, in some cases at least 35,000 and in other cases at least 50,000. Also, the Mw of the resulting polymer can be up to 1,000,00, in some cases up to 750,000, and in other cases up to 500,000. The Mw of the resulting polymer can be any value or range between any of the values recited above.

The styrenic copolymer according to the invention can be characterized as having a VICAT softening temperature of greater than 100° C., in some circumstances greater than 110° C., in other circumstances greater than 115° C., in some cases greater than 116° C., in other cases greater than 117° C., and in some instances greater than 118° C. and can be up to 135° C., in some cases up to 130° C. The VICAT softening temperature is determined according to ASTM-D1525. The VICAT softening temperature can be any value or range between any of the values recited above.

In order to form a thermoplastic sheet, the above-described styrenic copolymer is provided in polymer melt form, typically by heating the polymer composition above its melting temperature and the copolymer is then extruded to form a thermoplastic sheet.

In an embodiment of the invention, a compounded blend can be used that includes the present copolymer and one or more other polymers. Suitable other polymers that can be blend compounded with the present styrenic copolymer include, but are not limited to crystal polystyrene, high impact polystyrenes, poly-phenylene oxide, copolymers of styrene and maleic anhydride and/or C₁-C₁₂ linear, branched or cyclic alkyl (meth)acrylates, rubber-modified copolymers of styrene and maleic anhydride and/or C₁-C₁₂ linear, branched or cyclic alkyl(meth)acrylates, polycarbonates, poly-amides (such as the nylons), polyesters (such as polyethylene terephthalate, PET), polyolefins (such as polyethylene, polypropylene, and ethylene-propylene copolymers), polyvinylidene fluoride, acrylonitrile/(meth)acrylate copolymers, ethylene/vinyl acetate copolymers, ethylene vinyl alcohol copolymers, and combinations thereof.

When a compounded blend is used, the blend will typically include at least 10%, in some cases at least 25%, and in other cases at least 35% and up to 90%, in some cases up to 75%, and in other cases up to 65% by weight based on the blend of the present copolymer. Also, the blend will typically include at least 10%, in some cases at least 25%, and in other cases at least 35% and up to 90%, in some cases up to 75%, and in other cases up to 65% by weight based on the blend of the other polymers. The amount of the present copolymer and other polymers in the blend is determined based on the desired properties in the resulting thermoplastic sheet and/or formed article. The amount of the present polymer composition and other polymers in the blend can be any value or range between any of the values recited above.

The copolymer or blend can be extruded using conventional extrusion equipment. The extruder can be a back-to-back type or it can be a multi-zoned extruder having at least a first or primary zone to melt the polymer and a second extruder or zone.

As a non-limiting example, in the primary extruder or zone the polymer melt can be maintained at temperatures from about 425° F. to 450° F. (about 218 to 232° C.).

The polymer melt can then be fed from the primary extruder to the secondary extruder or pass from a primary zone to a secondary zone within the extruder maintained, as a non-limiting example, at a melt temperature of 269° F. to 290° F. (about 132° C. to 143° C.). In the secondary extruder or zone, the polymer melt passes through the extruder barrel by the action of an auger screw having deep flights and exerting low shear upon the polymer melt. The polymer melt is cooled by means of cooling fluid, typically oil which circulates around the barrel of the extruder. Generally the melt is cooled to a temperature of from about 250° F. to about 290° F. (about 121° C. to 143° C.).

The copolymer melt or blend can also contain conventional additives known in the art such as heat and light stabilizers (e.g., hindered phenols and phosphite or phosphonite stabilizers) typically in amounts of less than about 2 weight % based on the polymer blend or solution.

Other additives can be added to and/or compounded into the copolymer for thermoplastic sheets according to the invention. Further examples of suitable additives are softening agents; plasticizers, such as cumarone-indene resin, a terpene resin, and oils in an amount of about 2 parts by weight or less based on 100 parts by weight of the polymer; dyes, pigments; anti-blocking agents; slip agents; lubricants; coloring agents; antioxidants; ultraviolet light absorbers; fillers; anti-static agents; impact modifiers. Pigment can be white or any other color. The white pigment can be produced by the presence of titanium oxide, zinc oxide, magnesium oxide, cadmium oxide, zinc chloride, calcium carbonate, magnesium carbonate, etc., or any combination thereof in the amount of 0.1 to 20% in weight, depending on the white pigment to be used. The colored pigment can be produced by carbon black, phtalocyanine blue, Congo red, titanium yellow or any other coloring agent known in the printing industry.

Examples of anti-blocking agents, slip agents or lubricants are silicone oils, liquid paraffin, synthetic paraffin, mineral oils, petrolatum, petroleum wax, polyethylene wax, hydrogenated polybutene, higher fatty acids and the metal salts thereof, linear fatty alcohols, glycerine, sorbitol, propylene glycol, fatty acid esters of monohydroxy or polyhydroxy alcohols, phthalates, hydrogenated castor oil, beeswax, acetylated monoglyceride, hydrogenated sperm oil, ethylenebis fatty acid esters, and higher fatty amides. The organic anti-blocking agents can be added in amounts that will fluctuate from 0.1 to 2% in weight.

Examples of anti-static agents are glycerine fatty acid, esters, sorbitan fatty acid esters, propylene glycol fatty acid esters, stearyl citrate, pentaerythritol fatty acid esters, polyglycerine fatty acid esters, and polyoxethylene glycerine fatty acid esters. An anti-static agent may range from 0.01 to 2% in weight. Lubricants may range from 0.1 to 2% in weight. A flame retardant will range from 0.01 to 2% in weight; ultra-violet light absorbers will range from 0.1 to 1%; antioxidants will range from 0.1 to 1% in weight. The above compositions are expressed as percent of the total weight of the polymer blend.

Fillers, such as talc, silica, alumina, calcium carbonate, barium sulfate, metallic powder, glass spheres, barium stearate, calcium stearate, aluminum oxide, aluminum hydroxide, clay, titanium dioxide, diatomaceous earth and fiberglass, can be incorporated into the polymer composition in order to reduce cost or to add desired properties to the film or sheet. The amount of filler is desirably less than 10% of the total weight of the polymer composition as long as this amount does not alter the shrinking properties of the film or sheet when temperature is applied thereto.

The styrenic copolymer for thermoplastic sheets of the invention can include impact modifiers. Examples of impact modifiers include high impact polystyrene (HIPS), styrene/butadiene block copolymers, styrene/ethylene/butene/styrene, block copolymers, styrene/ethylene copolymers. The amount of impact modifier used is typically in the range of 0.5 to 25% of the total weight of polymer.

The thermoplastic material is generally extruded at atmospheric pressure. The thermoplastic material is cooled to ambient temperature typically below about 25° C., which is below the glass transition temperature of the polymer composition and the sheet is stabilized.

In an embodiment of the invention, thermoplastic sheets, typically from about 15 to about 300 mils thick can be extruded as slabs or as thin walled tubes, which are expanded and oriented over an expanding tubular mandrel to produce a tube, which is slit to produce sheets. These relatively thin sheets can be aged, typically 3 or 4 days and then can be thermoformed into articles, such as cups, trays, roasters, covers, lids or other containers or parts of containers suitable for use in heating food or liquids in a microwave oven.

Further to this embodiment, the thermoplastic sheets can be at least 5 mils, in some situations at least 10 mils, in other situations at least 15 mils, in some cases at least 20 mils, in other cases at least 30 mils, and in some instances at least 50 mils thick and can be up to 300 mils, in some cases up to 250 mils, in other cases up to 200 mils, in some instance up to 150 mils and in other instances up to 125 mils thick. The thickness of the thermoplastic sheet is determined by the intended end use and properties desired. The thickness of the thermoplastic sheet can be any value or range between any of the values recited above.

More specifically, once the desired temperature is reached, the thermoplastic sheet is formed into the desired shape by known processes such as plug assisted thermoforming where a plug pushes the thermoplastic sheet into a mold of the desired shape. Air pressure and/or vacuum can also be employed to mold the desired shape.

In an embodiment of the invention, the thermoformed article is used for packaging food and one or more of the processes described above are carried out in a protected and/or sterile environment and/or atmosphere.

When used to package food or consumable liquids, the thermoformed article can be self-closing or can include a container and a separate closure. Thus, in an embodiment of the invention, food or consumable liquids are placed into the container and the container is closed. Optionally, the container can then be shrink wrapped by a suitable material as is known in the art. Desirably, the shrink-wrapping can include printing on its surface. Alternatively, a label, covering at least a portion of the container can be placed thereon.

In a particular embodiment of the invention, the label is placed in the thermoforming machine prior to forming the container and adheres to the formed container.

In an embodiment of the invention, the above-described thermoplastic sheet may have a thermoplastic sheet flex modulus of about 3,000 psi, in some cases at least 5,000 psi, in some cases at least 6,000 psi, in other cases at least 7,000 psi, in some instances at least 8,000 psi and in other instances at least 10,000 psi.

The thermoplastic sheet flex modulus is determined using a standardized test coupon, which is subjected to three point bending under controlled conditions similar to those described in ASTM D-790 using an Instron Load Frame (4204 or 4400) with accessories, available from Instron Corporation, Canton, Mass. Load and deflection data are collected and evaluated. The slope of the load deflection curve, in the linear region, is a measure of the stiffness or rigidity of the material. Foam sheet materials, characteristically anisotropic, are evaluated in both the machine or “haul off” direction and the transverse or “across the sheet” direction. Flexural stiffness is the initial linear behavior of the material when subjected to flexural deformation. Stiffness is quantified by the respective value of the slope of initial linear portion of the curve. Modulus is the slope of the load-deflection curve normalized to the thickness. The test conditions used are: (a) 1.5 inch span, (b) 1 inch per minute crosshead speed, (c) 4 inch (length) specimen.

In another embodiment of the invention, any of the thermoplastic sheets described above may be co-extruded or laminated with one or more materials to form a two-layer structure where the materials make up one layer (a cap layer) and the thermoplastic sheet makes up the second layer or a sandwich structure thermoplastic sheet, where the thermoplastic sheet is included in the middle layer and the materials are included in the two outside layers. The materials that can be co-extruded or laminated can be selected from crystal polystyrene, high impact polystyrenes, polyphenylene oxide, copolymers of styrene and maleic anhydride and/or C₁-C₁₂ linear, branched or cyclic alkyl (meth)acrylates, rubber-modified copolymers of styrene and maleic anhydride and/or C₁-C₁₂ linear, branched or cyclic alkyl (meth)acrylates, polycarbonates, polyamides (such as the nylons), polyesters (such as polyethylene terephthalate, PET), polyolefins (such as polyethylene, polypropylene, and ethylene-propylene copolymers), polyvinylidene fluoride, acrylonitrile/(meth)acrylate copolymers such as those available under the trade name BAREX® from BP Chemicals Inc., Cleveland, Ohio, ethylene/vinyl acetate copolymers, ethylene vinyl alcohol copolymers, and combinations thereof.

More particularly, the above-described method may include the step of extruding or laminating a solid sheet cap layer over at least a portion of a top surface of the thermoplastic sheet.

Alternatively, the above-described method may include the steps of: extruding or laminating a top layer over at least a portion of a top surface of the thermoplastic sheet and extruding or laminating a bottom layer over at least a portion of a bottom surface of the thermoplastic sheet to form a sandwich structure thermoplastic sheet.

As described above, the present invention provides articles that are formed by thermoforming any of the above-described thermoplastic sheets to form articles. Because of the properties of the thermoplastic sheets, the articles can include containers suitable for use in microwave heating of food.

In an embodiment of the invention, the thermoplastic sheet or co-extruded sheets according to the invention have an IZOD notched impact value, determined according to ASTM D256, of at least 3.0, in some cases at least 4.75 and in other cases at least 5.25 ft.-lb./in.

In another embodiment of the invention, the thermoplastic sheet or co-extruded sheets according to the invention have a VICAT temperature (° C.) of at least 127.4, in some cases at least about 127.5, and in other cases up to about 128.7.

In another embodiment of the invention, the thermoplastic sheet or co-extruded sheets according to the invention have a swell index value of at least about 10, in some cases at least about 12 and in other cases at least about 14 and can be up to about 25. The swell index is determined by dissolving a thermoplastic sample (0.4 grams) in toluene (20 ml, 30 ml if the percent of insoluble material is expected to be least then 15%). The insoluble portion of the thermoplastic sample is separated from the soluble portion by centrifugation and dried to constant weight. The swell index is calculated as the ratio of the weight of wet gel to dry gel. The swell index of the thermoplastic sheet or co-extruded sheets can be any value or range between any of the values recited above.

In a further embodiment of the invention, the thermoplastic sheet or co-extruded sheets according to the invention have an elongation at break value of at least about 3%, in some cases at least about 6%, and in some cases at least about 10% and can be up to about 15%, determined according to ASTM D638. The strain at break of the thermoplastic sheet or co-extruded sheets can be any value or range between any of the values recited above.

The containers resulting from the present invention are suitable for packaging foods and can withstand the temperatures needed for heating foods in a microwave oven without the container breaking, deforming or leaking. Further, the containers maintain their form, especially upon removal of the container out of the microwave oven.

When the thermoplastic sheet is co-extruded as discussed above, the resulting multi-layer container is also suitable for use in microwave heating of food with the same type of desirable properties.

The present invention will further be described by reference to the following examples. The following examples are merely illustrative of the invention and are not intended to be limiting. Unless otherwise indicated, all percentages are by weight.

### EXAMPLES

In the Examples, the formed resins were injection molded into test specimens, which were tested by the following methods. The elongation at break was measured by ASTM-D638; the IZOD notched impact was measured by ASTM-D256; the VICAT heat distortion temperature was measured by ASTM-D1525.

### Example 1

This example compares thermoplastic sheets prepared according to the present invention.

The formulations for the thermoplastic sheets were prepared according to the Table 1 below:

TABLE 1

| Ingredient | A | B | C | D |
|---|---|---|---|---|
| Styrene | 69.30% | 69.30% | 69.30% | 69.30% |
| Maleic Anhydride | 10.50% | 10.50% | 10.50% | 10.50% |
| Polybutadiene | 20.00% | 15.00% | 10.00% | 0.00% |
| rubber | | | | |
| Partially | 0.00% | 5.00% | 10.00% | 20.00% |
| hydrogenated | | | | |
| styrene- | | | | |
| butadiene rubber¹ | | | | |
| ANNOX ™ PP18² | 0.2% | 0.2% | 0.2% | 0.2% |

¹ASAHI H300A available from Asahi, Japan.
²Antioxidant available from Great Lakes Chemical Co., Indianapolis, IN.

A solution containing maleic anhydride, polybutadiene rubber, partially hydrogenated styrene-butadiene rubber, and ANOX™ PP18 (octadecycyl-3-(3′,5′-di-tert-butyl-4′-hydroxyphenyl)propionate) was dissolved in styrene monomer, and then fed continuously to a completely filled polymerization reactor equipped with a turbine agitator similar to that of U.S. Pat. No. 2,769,804. Benzoyl peroxide initiator, 0.01% of the main stream, was added into the reactor in a separate stream. The reactor was stirred so that it was well mixed. The reacting mass was maintained at 126° C. by cooling through the reactor jacket. The average residence time in the reactor was 2.7 hours. The exit stream contained 52% polymer and was then fed continuously into a devolatilizer in which the unreacted monomer was removed. The final product was pelletized and molded into test specimens and testing was done using the methods outlined hereinabove.

The following results were obtained for the samples:

TABLE 2

| Property | A | B | C | D |
|---|---|---|---|---|
| IZOD notched | 4.75 | 5.10 | 5.20 | 3.50 |
| impact (ft-lbs/in) | | | | |
| Swell Index (%) | 13.3 | 14.5 | 17.1 | 18.1 |
| VICAT heat | 127.5 | 127.5 | 128.6 | 127.3 |
| distortion temp. (° C.) | | | | |
| Elongation at Break (%) | 10.5 | 14.0 | 5.8 | 4.0 |

The improved IZOD and swell index values demonstrate the toughness properties of the present thermoplastic sheet, which maintains good VICAT and elongation at break properties.

The polybutadiene rubber was replaced in 25% increments with the ASAHI H300A partially hydrogenated polybutadiene rubber. No degradation products were formed with the ASAHI H300A rubber.

### Example 2

The following experiment was done on a mini-line running at approximately 1 lb/hr. The system consisted of a chilled dissolver tank, feed tank, 2 reactors, devolatilizer drum, and extruder with a single holed die. The system was run as a single reactor system at approximately 50% solids. The single reactor used has a helix anchor for mixing. These experiments were done with a partially hydrogenated styrene butadiene rubber from ASAHI.

The feed formulations are listed in Table 3.

TABLE 3
CHARGE
COMPOSITION:

| | | | | |
|---|---|---|---|---|
| Styrene (wt %) | 83.50 | 83.50 | 83.50 | 83.50 |
| MA (wt %) | 5 | 5 | 5 | 5 |
| Primary Rubber | Poly- | Poly- | Poly- | Poly- |
| type | butadiene | butadiene | butadiene | butadiene |
| Primary Rubber | 5.2 | 5.2 | 5.2 | 5.2 |
| conc. % | | | | |
| Polybutene | 1.5 | 1.5 | 1.5 | 1.5 |
| H-100 (wt %) | | | | |
| Secondary Rubber | Styrene | Styrene | Styrene | Styrene |
| | Butadiene | Butadiene | Butadiene | Butadiene |
| Secondary rubber | 2.8 | 2.1 | 1.4 | 0.7 |
| conc. % | | | | |
| Third Rubber | ASAHI | ASAHI | ASAHI | ASAHI |
| | L601 | L601 | L601 | L601 |
| Third rubber | 0 | 0.7 | 1.4 | 2.1 |
| conc. % | | | | |
| Initiator type | TBPO | TBPO | TBPO | TBPO |
| Initiator (ppm) | 120 | 120 | 120 | 120 |

The polybutadiene rubber loading was kept constant at 5.2% in the feed batch. Styrene butadiene rubber and ASAHI L601 were blended to get 2.8% secondary rubber in the feed. The loading of ASASHI L601 was 0%, 25%, 50%, and 75% of the 2.8% secondary feed rubber. ASASHI L601 is a partially hydrogenated polybutadiene rubber available from ASASHI, Japan.

Table 4 shows the formulation in the resins and some physical properties.

TABLE 4
Formulation

| | | | | |
|---|---|---|---|---|
| Styrene (wt %) | 83.50 | 83.50 | 83.50 | 83.50 |
| MA (wt %) | 10 | 10 | 10 | 10 |
| Primary Rubber | Poly- | Poly- | Poly- | Poly- |
| type | butadiene | butadiene | butadiene | butadiene |
| Primary Rubber | 10.4 | 10.4 | 10.4 | 10.4 |
| conc. % | | | | |
| Polybutene | 3.0 | 3.0 | 3.0 | 3.0 |
| H-100 (wt %) | | | | |
| Secondary Rubber | Styrene | Styrene | Styrene | Styrene |
| | Butadiene | Butadiene | Butadiene | Butadiene |
| Secondary rubber | 5.6 | 4.2 | 2.8 | 1.4 |
| conc. % | | | | |
| Third Rubber | ASAHI | ASAHI | ASAHI | ASAHI |
| | L601 | L601 | L601 | L601 |
| Third rubber | 0 | 1.4 | 2.8 | 4.2 |
| conc. % | | | | |
| Swell Index | 12 | 13.1 | 13.5 | 13.9 |
| (%) | | | | |
| IZOD (ft-lbs/inch) | 1.595 | 1.85 | 1.527 | 1.235 |
| Strain at Break (%) | 9 | 14.5 | 6.5 | 5.5 |

The swell index increased with the partially hydrogenated L601 loading. The IZOD increased 27% but dropped as the L601 was increased. The IZOD for these samples was not as high as normal because particle size during the experiments was larger than normally observed. The strain @ break was the highest for a 25% partially hydrogenated loading.

### Example 3

Thermoplastic sheets were prepared using the rubber modified styrenic copolymer similar to that described in the above-discussed U.S. Application Publication 2005/0020756. The polybutadiene rubber was partially replaced with the partially hydrogenated styrene-butadiene rubber of the present invention.

The formulations of these thermoplastic sheets are shown in Table 5. The partially hydrogenated rubber, i.e., ASASHI H300A loading was 6.5 weight percent as a substitute of the Stereon 40A (polybutadiene obtained from Firestone) in the rubber modified copolymer. The polybutene loading in the copolymer was 2% and the extruder temperature varied from 230 to 310° C. as shown in Table 5.

TABLE 5

| | | | | | |
|---|---|---|---|---|---|
| 1 | 2 | 3 | 4 | 5 | 6 |

Main Feed Composition

| | | | | | | |
|---|---|---|---|---|---|---|
| Styrene (wt %) | 84.65 | 82.65 | 82.65 | 84.65 | 82.65 | 82.65 |
| MA (wt %) | 5.25 | 5.25 | 5.25 | 5.25 | 5.25 | 5.25 |
| Primary rubber (wt %) | 6.5 | 6.5 | 6.5 | 0 | 0 | 0 |
| Primary rubber type | Stereon | Stereon | Stereon | Stereon | Stereon | Stereon |
| | 40A | 40A | 40A | 40A | 40A | 40A |
| Secondary rubber (wt %) | 3.5 | 3.5 | 3.5 | 3.5 | 3.5 | 3.5 |
| Secondary rubber type | Asaprene | Asaprene | Asaprene | Asaprene | Asaprene | Asaprene |
| | 625A | 625A | 625A | 625A | 625A | 625A |
| Third Rubber (wt %) | 0 | 0 | 0 | 6.5 | 6.5 | 6.5 |
| Third rubber type | Asahi | Asahi | Asahi | Asahi | Asahi | Asahi |
| | H300A | H300A | H300A | H300A | H300A | H300A |
| Polybutene (wt %) | 0 | 2 | 2 | 0 | 2 | 2 |
| Polybutene Type | H-100 | H-100 | H-100 | H-100 | H-100 | H-100 |
| Irganox 1076 Antioxidant 3 (wt %) | 0.1 | 0.1 | 0.1 | 0.1 | 0.1 | 0.1 |
| Total rubber | 10 | 10 | 10 | 10 | 10 | 10 |

Reactor Conditions

| | | | | | | |
|---|---|---|---|---|---|---|
| Batch Temp (° C.) | 121 | 121 | 121 | 121 | 121 | 121 |
| Level (lbs) | 180 | 180 | 180 | 180 | 180 | 180 |
| Jacket | 119 | 119 | 119 | 119 | 119 | 119 |
| Agitator Speed (rpm) | 75 | 75 | 75 | 75 | 75 | 75 |
| Solids (wt %) | 50 | 50 | 50 | 50 | 50 | 50 |
| Res Time (hrs) | 1.8 | 1.8 | 1.8 | 1.8 | 1.8 | 1.8 |

Extruder Conditions

| | | | | | | |
|---|---|---|---|---|---|---|
| Extruder Temp Zone 1 (° C.) | 230 | 230 | 230 | 230 | 230 | 230 |
| Extruder Temp Zone 2-6 average (° C.) | 310 | 310 | 260 | 310 | 310 | 260 |
| Extruder End Plate Temp | 280 | 280 | 280 | 280 | 280 | 280 |

Testing Results

| | | | | | | |
|---|---|---|---|---|---|---|
| Mw (k) | 170.9 | 170.9 | 176.6 | 171.906 | 170.525 | 204.373 |
| Dynatup Impact Total Energy (ft × lbs) | 11.87 | 11.74 | 11.71 | 13.13 | 13.21 | 14.69 |
| DSC Tg (° C.) | 130.4 | 129.404 | 132.404 | 134.07 | 130.737 | 134.066 |
| Flexural Modulus (kpsi) | 338.743 | 314.915 | 309.188 | 344.26 | 318.786 | 325.459 |
| Youngs Tensile Modulus (kpsi) | 315.239 | 286.797 | 282.876 | 313.403 | 289.715 | 295.452 |
| Styrene Monomer (ppm) | 564 | 262 | 416 | 212.6 | 150.6 | 189.52 |
| Butadiene Dimer (ppm) | 55 | 44 | 28 | 39 | 17 | 10 |

Solutions containing the components of the formulations of Table 5 were prepared in a manner similar to that of Example 1. The final product was pelletized and molded into test specimens and testing was done using methods outlined hereinabove.

The properties for the resulting resins appear in Table 5. Comparisons can be made between Examples 1 and 4, 2 and 5, and 3 and 6, wherein Examples 4, 5, and 6 contain partially hydrogenated rubber, i.e., Asahi H300A. In general, Examples 4, 5, and 6 when compared to Examples 1, 2, and 3, respectively show an increase in the flexural modulus and the tensile modulus in addition to a decrease in the amount of styrene monomer residuals and the butadiene dimer, and, therefore, a decrease in the odor generally associated with the butadiene dimer.

While the present invention has been particularly set forth in terms of specific embodiments thereof, it will be understood in view of the instant disclosure that numerous variations upon the invention are now enabled yet reside within the scope of the invention.

Accordingly, the invention is to be broadly construed and limited only by the scope and spirit of the claims now appended hereto.

What is claimed is:

1. A rubber modified styrenic copolymer composition comprising:
about 55% to about 94% by weight of one or more styrenic monomers; and
about 2% to about 25% by weight of one or more maleate-type monomers; and
about 4% to about 20% by weight of an elastomer composition comprising:
about 4% to about 20% by weight of one or more partially hydrogenated elastomeric polymers comprising repeat units from one or more monomers according to the formula 63% by weight 1,4 cis/trans butadiene, 1% by weight 1,2 vinyl butadiene, 26% by weight tetramethylene, and 10% by weight butylene.

2. The styrenic copolymer composition of claim 1 wherein the amount of said partially hydrogenated elastomeric polymers range from about 10% to about 20% by weight based on the weight of the styrenic copolymer.

3. The styrenic copolymer composition of claim 2 wherein the amount of said partially hydrogenated elastomeric polymers ranges from about 15% to about 20% by weight based on the weight of the styrenic copolymer.

4. The styrenic copolymer composition of claim 1 wherein said partially hydrogenated elastomeric polymers have the structure

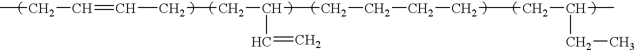

5. The styrenic copolymer composition of claim 1 wherein the styrenic monomers are selected from the group consisting of styrene, p-methyl styrene, α-methyl styrene, tertiary butyl styrene, dimethyl styrene, nuclear brominated or chlorinated derivatives thereof and combinations thereof.

6. The styrenic copolymer composition of claim 1 wherein the maleate-type monomers are selected from the group consisting of maleic anhydride, maleic acid, fumaric acid, C₁-C₁₂ linear, branched or cyclic alkyl esters of maleic acid, C₁-C₁₂ linear, branched or cyclic alkyl esters of fumaric acid, itaconic acid, C₁-C₁₂ linear, branched or cyclic alkyl esters of itaconic acid, and itaconic anhydride.

7. The styrenic copolymer composition of claim 1 wherein said elastomer composition further comprises from about 0.1 to about 16% by weight, based on the weight of the styrenic copolymer, one or more high molecular weight elastomeric polymers having a number average molecular weight of greater than 12,000.

8. The styrenic copolymer composition of claim 7 wherein said high molecular weight elastomeric polymers are selected from the group consisting of homopolymers of butadiene, homopolymers of isoprene, and random, block, AB diblock, and ABA triblock copolymers of a conjugated diene with a styrenic monomer and/or acrylonitrile.

9. The styrenic copolymer composition of claim 7 wherein said high molecular weight elastomeric polymers are one or more block copolymers selected from the group consisting of diblock and triblock copolymers of styrene-butadiene, styrene-butadiene-styrene, styrene-isoprene, styrene-isoprene-styrene, partially hydrogenated styrene-isoprene-styrene and combinations thereof.

10. The styrenic copolymer composition of claim 1 wherein the partially hydrogenated elastomeric polymer comprises styrene-butadiene rubber having a 1,4 cis/trans content of at least 63% by weight, a 1,2-vinyl content of at least 1% by weight, based on the weight of the styrene butadiene rubber.

11. The styrenic copolymer composition of claim 1 wherein the partially hydrogenated elastomeric polymer is selected from the group consisting of polybutadienes and styrene polybutadienes.

12. The styrenic copolymer of claim 1 wherein the styrenic and maleate-type monomers and copolymers formed therefrom comprise a continuous phase and the elastomer composition comprises a dispersed particulate phase having particles with an average particle size of from about 0.1 microns to about 11 microns.

13. The styrenic copolymer composition of claim 1 further comprising one or more additives selected from the group consisting of heat stabilizers, light stabilizers, softening agents; plasticizers, dyes, pigments; anti-blocking agents; slip agents; lubricants; coloring agents; antioxidants; ultraviolet light absorbers; fillers; anti-static agents; impact modifiers, and combinations thereof.

14. The styrenic copolymer composition of claim 1 further comprising from about 0.1 to about 8.0% by weight of polybutene.

15. A thermoplastic sheet comprising a styrenic copolymer composition formed by polymerizing a mixture comprising:
about 55% to about 94% by weight of one or more styrenic monomers; and
about 2% to about 25% by weight of one or more maleate-type monomers; and
about 4% to about 20% by weight of an elastomer composition comprising:
about 4% to about 20% by weight, based on the weight of the styrenic copolymer, of one or more partially hydrogenated elastomeric polymers comprising repeat units from on or more monomers according to the formula 63% by weight 1,4 cis/trans butadiene, 1% by weight 1,2 vinyl butadiene, 26% by weight tetramethylene, and 10% by weight butylene.

16. The thermoplastic sheet of claim 15 wherein the styrenic monomers are selected from the group consisting of styrene, p-methyl styrene, α-methyl styrene, tertiary butyl styrene, dimethyl styrene, nuclear brominated or chlorinated derivatives thereof and combinations thereof.

17. The thermoplastic sheet of claim 15 wherein the maleate-type monomers are selected from the group consisting of maleic anhydride, maleic acid, fumaric acid, C₁-C₁₂ linear, branched or cyclic alkyl esters of maleic acid, C₁-C₁₂ linear, branched or cyclic alkyl esters of fumaric acid, itaconic acid, C₁-C₁₂ linear, branched or cyclic alkyl esters of itaconic acid, and itaconic anhydride.

18. The thermoplastic sheet of claim 15 wherein said elastomer composition further comprises from about 0.1 to about 16% by weight, based on the weight of the styrenic copolymer composition, one or more high molecular weight elastomeric polymers having a number average molecular weight of greater than 12,000.

19. The thermoplastic sheet of claim 18 wherein said high molecular weight elastomeric polymers are selected from the group consisting of homopolymers of butadiene, homopolymers of isoprene, and random, block, AB diblock, and ABA triblock copolymers of a conjugated diene with a styrenic monomer and/or acrylonitrile.

20. The thermoplastic sheet of claim 18 wherein the high molecular weight elastomeric polymers are one or more block copolymers selected from the group consisting of diblock and triblock copolymers of styrene-butadiene, styrene-butadiene-styrene, styrene-isoprene, styrene-isoprene-styrene, partially hydrogenated styrene-isoprene-styrene and combinations thereof.

21. The thermoplastic sheet of claim 15 wherein the amount of said partially hydrogenated elastomeric polymers range from about 10% to about 20% by weight based on the weight of the styrenic copolymer composition.

22. The thermoplastic sheet of claim 15 wherein the amount of said partially hydrogenated elastomeric polymers ranges from about 15% to about 20% by weight based on the weight of the styrenic copolymer composition.

23. The thermoplastic sheet of claim 15 wherein said partially hydrogenated elastomeric polymers have the structure:

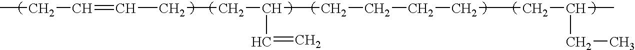

24. The thermoplastic sheet of claim 15 wherein the styrenic and maleate-type monomers and copolymers formed therefrom comprise a continuous phase and the elastomeric polymers comprise a dispersed particulate phase having particles with an average particle size of from about 0.1 microns to about 11 microns.

25. The thermoplastic sheet of claim 15 wherein the weight average molecular weight of the formed copolymer is from about 20,000 to about 1,000,000.

26. The thermoplastic sheet of claim 15 wherein the thermoplastic sheet has an IZOD notched impact value of at least 3.0 ft-lb/in determined according to ASTM D256.

27. The thermoplastic sheet of claim 15 wherein the thermoplastic sheet has a swell index value of from about 10 to about 25%.

28. The thermoplastic sheet according to claim 15 wherein the thermoplastic sheet has a strain at break value of from about 3 to about 15%, determined according to ASTM D638.

29. The thermoplastic sheet according to claim 15 wherein said styrenic copolymer composition further comprises from about 0.1 to about 8.0% by weight of polybutene.

30. The thermoplastic sheet according to claim 15, wherein the styrenic copolymer composition further comprises one or more additives selected from the group consisting of heat stabilizers, light stabilizers, softening agents; plasticizers, dyes, pigments; anti-blocking agents; slip agents; lubricants; coloring agents; antioxidants; ultraviolet light absorbers; fillers; anti-static agents; impact modifiers, and combinations thereof.

31. An article produced from the thermoplastic sheet according to claim 15.

32. The article according to claim 30, wherein the article is produced by thermoforming the thermoplastic sheet.

33. A container suitable for use in microwave heating of food formed from the thermoplastic sheet composition according to claim 15.

34. An article produced from the styrenic copolymer composition of claim 1.

35. A method of making a thermoplastic sheet comprising:
providing a polymer composition in polymer melt form prepared by polymerizing a mixture comprising:
about 55% to about 94% by weight of one or more styrenic monomers; and
about 2% to about 25% by weight of one or more maleate-type monomers; and
about 4% to about 20% by weight of an elastomer composition comprising:
about 4% to about 20% by weight, based on the weight of the styrenic copolymer, of one or more partially hydrogenated elastomeric polymers comprising repeat units from on or more monomers according to the formula 63% by weight 1,4 cis/trans butadiene, 1% by weight 1,2 vinyl butadiene, 26% by weight tetramethylene, and 10% by weight butylenes, and
extruding the polymer composition to provide a thermoplastic sheet.

36. The method of making a thermoplastic sheet according to claim 35, wherein said polymer composition) further comprises one or more high molecular weight elastomeric polymers in an amount ranging from about 0.1 to about 16% by weight and having a number average molecular weight of greater than 12,000.

37. The method of making a thermoplastic sheet according to claim 35 wherein said polymer composition further comprises from about 0.1 to about 8.0% by weight of a polybutene.

38. The method of making a thermoplastic sheet according to claim 35, wherein the polymer composition is prepared by solution or bulk polymerization in the presence of from 0.01 to 0.1 weight % based on the mixture of a tetra functional peroxide initiator of the formula: 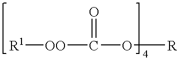
wherein R¹ is selected from the group consisting of C₄₋₆ t-alkyl radicals and R is a neopentyl group, in the absence of a cross linking agent.

39. The method of making a thermoplastic sheet according to claim 38, wherein the tetrafunctional initiator is selected from the group consisting of tetrakis-(t-amylperoxycarbonyloxymethyl)methane, and tetrakis-(t-butylperoxycarbonyloxymethyl)methane.

40. The method of making a thermoplastic sheet according to claim 35, wherein a nucleating agent selected from the group consisting of calcium carbonate, barium stearate, calcium stearate, aluminum oxide, aluminum hydroxide, talc, clay, titanium dioxide, silica, diatomaceous earth, mixtures of citric acid and sodium bicarbonate is added to the polymer composition prior to extruding.

41. The method of making a thermoplastic sheet according to claim 35, wherein the styrenic monomers are selected from the group consisting of styrene, p-methyl styrene, α-methyl styrene, tertiary butyl styrene, dimethyl styrene, nuclear brominated or chlorinated derivatives thereof and combinations thereof.

42. The method of making a thermoplastic sheet according to claim 35, wherein the maleate-type monomers are selected from the group consisting of maleic anhydride, maleic acid, fumaric acid, C₁-C₁₂ linear, branched or cyclic alkyl esters of maleic acid, C₁-C₁₂ linear, branched or cyclic alkyl esters of fumaric acid, itaconic acid, C₁-C₁₂ linear, branched or cyclic alkyl esters of itaconic acid, and itaconic anhydride.

43. The method of making a thermoplastic sheet according to claim 36, wherein the high molecular weight elastomeric polymers are selected from the group consisting of homopolymers of butadiene or isoprene, and random, block, AB diblock, or ABA triblock copolymers of a conjugated diene with a styrenic monomer and/or acrylonitrile.

44. The method of making a thermoplastic sheet according to claim 36, wherein the high molecular weight elastomeric polymers are one or more block copolymers selected from the group consisting of diblock and triblock copolymers of styrene-butadiene, styrene-butadiene-styrene, styrene-isoprene, styrene-isoprene-styrene, partially hydrogenated styrene-isoprene-styrene.

45. The method of making a thermoplastic sheet according to claim 35, wherein the partially hydrogenated elastomer polymers comprise repeat units resulting from the polymerization of one or monomers selected from the group consisting of 1,4 butadiene, 1,2 butadiene, tetramethylene, and butylenes.

46. The method of making a thermoplastic sheet of claim 35 wherein the amount of said partially hydrogenated elastomeric polymers ranges from about 10% to about 20% by weight based on the weight of the styrenic copolymer.

47. The method of making a thermoplastic sheet of claim 35 wherein the amount of said partially hydrogenated elastomeric polymers ranges from about 15% to about 20% by weight based on the weight of the styrenic copolymer.

48. The method of making a thermoplastic sheet of claim 35 wherein said partially hydrogenated elastomeric polymers have a structural formula of 63%, 1,4 cis/trans butadiene, 1% 1,2 vinyl butadiene, 26% tetramethylene, and 10% butylene.

49. The method of making a thermoplastic sheet according to claim 35, wherein the partially hydrogenated elastomeric polymers are selected from the group consisting of 63% 1,4 cis/trans butadiene, 1% 1,2 vinyl butadiene, 26% tetramethylene, and 10% butylene.

50. The method of making a thermoplastic sheet according to claim 35, wherein the partially hydrogenated elastomeric polymers are styrene-butadiene rubbers.

51. The method of making a thermoplastic sheet according to claim 35, wherein the partially hydrogenated elastomer polymers contain one or more functional groups selected from the group consisting of 63% 1,4 cis/trans butadiene, 1% 1,2 vinyl butadiene, 26% tetramethylene, and 10% butylene.

52. The method of making a thermoplastic sheet according to claim 35, wherein the styrenic and maleate-type monomers and copolymers formed therefrom comprise a continuous phase and the elastomeric polymers comprise a dispersed particulate phase having particles with an average particle size of from about 0.1 microns to about 11 microns.

53. The method of making a thermoplastic sheet according to claim 35 wherein the thermoplastic sheet has an IZOD notched impact value, determined according to ASTM D256, of at least 3.0 ft.-lb./in.

54. The method of making a thermoplastic sheet according to claim 35, wherein the thermoplastic sheet has a swell index value of from about 10.0 to about 25%.

55. The method of making a thermoplastic sheet according to claim 35, wherein the thermoplastic sheet has a strain at break value of from about 3 to about 15%, determined according to ASTM D638.

56. The method of making a thermoplastic sheet according to claim 35, wherein the polymer composition further comprises one or more additives selected from the group consisting of heat stabilizers, light stabilizers, softening agents; plasticizers, dyes, pigments; anti-blocking agents; slip agents; lubricants; coloring agents; antioxidants; ultraviolet light absorbers; fillers; anti-static agents; impact modifiers, and combinations thereof.

57. A thermoplastic sheet made according to the method of claim 35.

58. An article produced from the thermoplastic sheet according to claim 57.

59. A container suitable for use in microwave heating of food formed from the thermoplastic sheet according to claim 57.

60. The method of making a thermoplastic sheet according to claim 35 comprising the step of extruding or laminating a solid sheet cap layer over at least a portion of a top surface of the thermoplastic sheet.

61. The method of making a thermoplastic sheet according to claim 60, wherein the solid sheet cap layer comprises a resin selected from the group consisting of crystal polystyrene, high impact polystyrenes, polyphenylene oxide, copolymers of styrene and maleic anhydride and/or C₁-C₁₂ linear, branched or cyclic alkyl (meth)acrylates, rubber-modified copolymers of styrene and maleic anhydride and/or C₁-C₁₂ linear, branched or cyclic alkyl (meth)acrylates, polycarbonates, polyamides, polyesters, polyolefins, polyvinylidene fluoride, acrylonitrile/(meth)acrylate copolymers, ethylene/vinyl acetate copolymers, ethylene vinyl alcohol copolymers, and combinations thereof.

62. A thermoplastic sheet made according to the method of claim 60.

63. An article produced from the thermoplastic sheet according to claim 62.

64. A container suitable for use in microwave heating of food formed from the thermoplastic sheet according to claim 62.

65. The method of making a thermoplastic sheet according to claim 35 comprising the steps of:
extruding or laminating a top layer over at least a portion of a top surface of the thermoplastic sheet: and
extruding or laminating a bottom layer over at least a portion of a bottom surface of the thermoplastic sheet to form a sandwich structure thermoplastic sheet.

66. The method of making a thermoplastic sheet according to claim 65, wherein the top layer and the bottom layer independently comprises a resin selected from the group consisting of crystal polystyrene, high impact polystyrenes, polyphenylene oxide, copolymers of styrene and maleic anhydride and/or C₁-C₁₂ linear, branched or cyclic alkyl (meth)acrylates, rubber-modified copolymers of styrene and maleic anhydride and/or C₁-C₁₂ linear, branched or cyclic alkyl (meth)acrylates, polycarbonates, polyamides, polyesters, polyolefins, polyvinylidene fluoride, acrylonitrile/(meth)acrylate copolymers, ethylene/vinyl acetate copolymers, ethylene vinyl alcohol copolymers, and combinations thereof.

67. A sandwich structure thermoplastic sheet made according to the method of claim 66.

68. An article produced from the sandwich structure thermoplastic sheet according to claim 67.

69. A container suitable for use in microwave heating of food formed from the sandwich structure thermo-plastic sheet according to claim 68.

70. A two layer thermoplastic sheet comprising a first layer that includes the thermoplastic sheet according to claim 35 and a second layer comprising one or more resins selected from the group consisting of crystal polystyrene, high impact polystyrenes, polyphenylene oxide, copolymers of styrene and maleic anhydride and/or C₁-C₁₂ linear, branched or cyclic alkyl (meth)acrylates, rubber-modified copolymers of styrene and maleic anhydride and/or C₁-C₁₂ linear, branched or cyclic alkyl (meth)acrylates, polycarbonates, polyamides, polyesters, polyolefins, polyvinylidene fluoride, acrylonitrile/(meth)acrylate copolymers, ethylene/vinyl acetate copolymers, ethylene vinyl alcohol copolymers, and combinations thereof.

71. An article produced from the two layer thermo-plastic sheet according to claim 70.

72. A container suitable for use in microwave heating of food formed from the two layer thermoplastic sheet according to claim 70.

73. A sandwich structure thermoplastic sheet comprising a middle layer that includes the thermo-plastic sheet according to claim 35, and a top layer and a bottom layer independently comprising a resin selected from the group consisting of crystal polystyrene, high impact polystyrenes, polyphenylene oxide, copolymers of styrene and maleic anhydride and/or C₁-C₁₂ linear, branched or cyclic alkyl(meth)acrylates, rubber-modified copolymers of styrene and maleic anhydride and/or C₁-C₁₂ linear, branched or cyclic alkyl (meth)acrylates, polycarbonates, polyamides, polyesters, polyolefins, polyvinylidene fluoride, acrylonitrile/(meth)acrylate copolymers, ethylene/vinyl acetate copolymers, ethylene vinyl alcohol copolymers, and combinations thereof.

74. An article produced from the sandwich structure thermoplastic sheet according to claim 73.

75. A container suitable for use in microwave heating of food formed from the sandwich structure thermoplastic sheet according to claim 73.

76. A container suitable for use in microwave heating of food formed by thermoforming a thermoplastic sheet comprising a styrenic copolymer composition formed by polymerizing a mixture comprising:
about 55% to about 94% by weight of one or more styrenic monomers; and
about 2% to about 25% by weight of one or more maleate-type monomers; and
about 4% to about 20% by weight of an elastomer composition comprising:
about 4% to about 20% by weight, based on the weight of the styrenic copolymer, of one or more partially hydrogenated elastomeric polymers comprising repeat units from on or more monomers according to the formula 63% 1,4 cis/trans butadiene, 1% 1,2 vinyl butadiene, 26% tetramethylene, and 10% butylene.

77. A container of claim 76 wherein said elastomer composition further comprises from about 0.1 to about 16% by weight, based on the weight of the styrenic copolymer composition, one or more high molecular weight elastomeric polymers having a number average molecular weight of greater than 12,000.

78. A container of claim 76 wherein said styrenic copolymer composition further comprises from about 0.1 to about 8.0% by weight, based on the weight of said styrenic copolymer composition, polybutene.
